(19) United States
(12) Patent Application Publication
(10) Pub. No.: US 2026/0290664 A1
(43) Pub. Date: Sep. 24, 2026

(54) ALLOY POWDER COMPOSITIONS AND INDUCTORS

(71) Applicant: CHILISIN ELECTRONICS CORP., Taoyuan City (TW)

(72) Inventors: Zheng-I LEE, Taoyuan City (TW); Chun-Chuan CHAN, Taoyuan City (TW); Chau-Chyun CHUNG, Taoyuan City (TW)

(21) Appl. No.: 19/574,462

(22) Filed: Mar. 23, 2026

Related U.S. Application Data
(60) Provisional application No. 63/776,288, filed on Mar. 24, 2025.

(30) Foreign Application Priority Data
Mar. 18, 2026 (TW) 115110244

(51) Int. Cl. H01F 1/147; H01F 27/255

(52) U.S. Cl. CPC H01F 1/14791; H01F 27/255

(57) ABSTRACT

An alloy powder composition includes a first magnetic powder, a second magnetic powder, and a third magnetic powder in specific proportions. The first magnetic powder includes a first amorphous alloy, a first nanocrystalline alloy, or a first crystalline alloy. The second magnetic powder includes a second amorphous alloy, a second nanocrystalline alloy, or a second crystalline alloy. The third magnetic powder includes a pure iron powder or a third crystalline alloy.

### CROSS-REFERENCE TO RELATED APPLICATION

This application claims priority to U.S. Provisional Application Ser. No. 63/776,288 filed Mar. 24, 2025, and Taiwan Application Serial Number 115110244, filed Mar. 18, 2026, the disclosures of which are incorporated herein by reference in their entireties.

### BACKGROUND

### Field of Invention

The present disclosure relates to an alloy powder composition and an inductor, and more particularly to an alloy powder composition including three types of magnetic powders and an inductor including the same.

### Description of Related Art

Conventional electronic devices, such as smartphones, typically have magnetic elements, such as inductors. Many of these magnetic elements are made from alloy powder compositions, which may be required to have high packing density, high permeability, and low core loss to meet the requirements of certain electronic devices.

### SUMMARY

The present disclosure is to provide an alloy powder composition including three types of magnetic powders, wherein each magnetic powder includes an amorphous alloy, a nanocrystalline alloy, a crystalline alloy and/or a pure iron powder. The disclosed alloy powder composition has high packing density, high permeability, and low core loss, which is beneficial in improving the efficiency and high-frequency performance of inductors and improving power conversion efficiency.

One aspect of the present disclosure is to provide an alloy powder composition. Based on 100 weight percent of the alloy powder composition, the alloy powder composition includes 5 to 90 weight percent of a first magnetic powder, 5 to 90 weight percent of a second magnetic powder, and 5 to 90 weight percent of a third magnetic powder. The first magnetic powder includes a first amorphous alloy, a first nanocrystalline alloy, or a first crystalline alloy. The second magnetic powder includes a second amorphous alloy, a second nanocrystalline alloy, or a second crystalline alloy. The third magnetic powder includes a pure iron powder or a third crystalline alloy.

In some embodiments, the first crystalline alloy includes a first Fe—Si—Cr alloy, a first Fe—Si—Al alloy, a first Fe—Si alloy, a first Fe—Si—Cr—Al alloy, or a first Fe—Si—Cr—Ni alloy. In some embodiments, the second crystalline alloy includes a second Fe—Si—Cr alloy, a second Fe—Si—Al alloy, a second Fe—Si alloy, a second Fe—Si—Cr—Al alloy, or a second Fe—Si—Cr—Ni alloy. In some embodiments, the third crystalline alloy includes a Fe—Ni alloy, a third Fe—Si—Cr alloy, a third Fe—Si—Al alloy, or a third Fe—Si alloy.

In some embodiments, the alloy powder composition includes 10 to 80 weight percent of the first magnetic powder, 10 to 80 weight percent of the second magnetic powder, and 10 to 80 weight percent of the third magnetic powder.

In some embodiments, the alloy powder composition includes 10 to 60 weight percent of the first magnetic powder, 20 to 70 weight percent of the second magnetic powder, and 20 to 70 weight percent of the third magnetic powder.

In some embodiments, the alloy powder composition includes 10 to 40 weight percent of the first magnetic powder, 20 to 40 weight percent of the second magnetic powder, and 20 to 70 weight percent of the third magnetic powder.

In some embodiments, a median particle diameter D50 of the first magnetic powder a is 2 μm to 36 μm, a median particle diameter D50 of the second magnetic powder is 2 μm to 35 μm, and a median particle diameter D50 of the third magnetic powder is 0.5 μm to 15 μm.

In some embodiments, a density of the alloy powder composition is 5 g/cm³ to 8 g/cm³.

In some embodiments, a density of the alloy powder composition is 5.5 g/cm³ to 7.5 g/cm³.

In some embodiments, a relative permeability (μᵣ) of the alloy powder composition is 10 to 70 under test conditions at a frequency of 1 MHz.

In some embodiments, a relative permeability of the alloy powder composition is 30 to 65 under test conditions at a frequency of 1 MHz.

In some embodiments, a core loss of the alloy powder composition is 200 kW/m³ to 1500 kW/m³ under test conditions at a frequency of 1 MHz and a magnetic flux density amplitude of 30 mT.

In some embodiments, a core loss of the alloy powder composition is 200 kW/m³ to 950 KW/m³ under test conditions at a frequency of 1 MHz and a magnetic flux density amplitude of 30 mT.

In some embodiments, a Vickers hardness of the first magnetic powder is 300 MPa to 700 MPa. In some embodiments, a Vickers hardness of the second magnetic powder is 300 MPa to 700 MPa. In some embodiments, a Vickers hardness of the third magnetic powder is 100 MPa to 450 MPa.

In some embodiments, the Vickers hardness of the third magnetic powder is less than the Vickers hardness of the first magnetic powder and the Vickers hardness of the second magnetic powder.

In some embodiments, the Vickers hardness of the third magnetic powder is equal to the Vickers hardness of the first magnetic powder and the Vickers hardness of the second magnetic powder.

In some embodiments, a particle diameter of the first magnetic powder is greater than, equal to, or smaller than a particle diameter of the second magnetic powder.

In some embodiments, a particle size of the third magnetic powder is smaller than a particle size of the first magnetic powder and a particle size of the second magnetic powder.

One aspect of the present disclosure is to provide an inductor. The inductor includes a magnetic layer and an electrically conductive circuit disposed in the magnetic layer, wherein the magnetic layer includes the above-mentioned alloy powder composition.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic three-dimensional view of an inductor in accordance with some embodiments of the present disclosure.

FIG. 2 is a cross-sectional view obtained from a line A-A′ in FIG. 1.

### DETAILED DESCRIPTION

In the present specification, a range represented by “one value to another value” is a summary representation that avoids enumerating all the values in the range in the specification. Therefore, the recitation of a particular numerical range covers any numerical value within the numerical range and the smaller numerical range defined by any numerical values within the numerical range, as if the arbitrary value and the smaller numerical range are expressly stated in the specification. As used herein, the term “and/or” includes any and all combinations of one or more of the associated listed items.

It will be understood that, although the terms “first,” “second,” etc. may be used herein to describe various elements, these elements should not be limited by these terms. These terms are only used to distinguish one element from another. For example, a “first element” may be termed a “second element,” and, similarly, a “second element” may be termed a “first element,” without departing from the scope of the embodiments.

In addition, when a number or numerical range is described using terms such as “about,” “approximately,” “substantially,” or other similar expressions, such terms are intended to encompass values within a reasonable range of the recited value, as would be understood by a person having ordinary skill in the art, for example within +10% of the recited value. For example, the term “about 5 μm” encompasses a size range from 4.5 μm to 5.5 μm.

An alloy powder composition including two types of magnetic powders is currently known. However, problems exist in the conventional binary alloy powder composition, such as low packing density, low permeability, high core loss, and so on. The present application discloses a ternary alloy powder composition including three types of magnetic powders. The disclosed ternary alloy powder composition exhibits advantages over conventional binary alloy powder composition, including high packing density, high permeability, and low core loss. Furthermore, compared to conventional binary alloy powder composition, the disclosed ternary alloy powder composition includes an additional magnetic powder, which allows for adjustments to the materials and proportions of the composition to further modify the characteristics of the inductor.

The present disclosure provides an alloy powder composition. Based on 100 weight percent of the alloy powder composition, the alloy powder composition includes 5 to 90 weight percent of a first magnetic powder, 5 to 90 weight percent of a second magnetic powder, and 5 to 90 weight percent of a third magnetic powder. The first magnetic powder includes a first amorphous alloy, a first nanocrystalline alloy, or a first crystalline alloy. The second magnetic powder includes a second amorphous alloy, a second nanocrystalline alloy, or a second crystalline alloy. The third magnetic powder includes a pure iron powder or a third crystalline alloy.

It should be noted that the “amorphous alloys,” the “nanocrystalline alloys,” and the “crystalline alloys” in the present disclosure are all soft magnetic materials. The disclosed amorphous alloy is the solid metallic material that maintains a short-range ordered and long-range disordered structure in the solid state, in which crystal nucleation is suppressed during solidification by rapid cooling or alloy design. Because the atomic arrangement of the amorphous alloy is disordered and irregular, the grain size cannot be directly observed. The disclosed nanocrystalline alloy is composed of ultrafine grains, which are usually formed by the nucleation and growth of amorphous precursor alloys at appropriate annealing temperatures. Magnetic nanoscrystals (α-Fe) may be precipitated in the amorphous alloy, wherein the crystal size of the a-Fe crystals is in a range from about 1 nm to about 100 nm, and a typical grain size is in a range from about 10 nm to about 20 nm. Compared to conventional crystalline metal, the disclosed nanocrystalline alloy has improved properties, including high permeability, high saturation magnetic flux intensity, low coercive force, and low core loss. The crystals of the disclosed crystalline alloy are arranged in a long-range ordered structure, and the crystal size is in a range from several hundred nanometers to several millimeters.

In some embodiments, the first crystalline alloy includes a first Fe—Si—Cr alloy, a first Fe—Si—Al alloy, a first Fe—Si alloy, a first Fe—Si—Cr—Al alloy, or a first Fe—Si—Cr—Ni alloy. In some embodiments, the second crystalline alloy includes a second Fe—Si—Cr alloy, a second Fe—Si—Al alloy, a second Fe—Si alloy, a second Fe—Si—Cr—Al alloy, or a second Fe—Si—Cr—Ni alloy. In some embodiments, the third crystalline alloy includes a Fe—Ni alloy, a third Fe—Si—Cr alloy, a third Fe—Si—Al alloy, or a third Fe—Si alloy.

It could be understood that the compositions of the “first Fe—Si—Cr alloy,” the “second Fe—Si—Cr alloy,” and the “third Fe—Si—Cr alloy” of the present disclosure may be identical or similar. The compositions of the “first Fe—Si—Al alloy,” the “second Fe—Si—Al alloy,” and the “third Fe—Si—Al alloy” of the present disclosure may be identical or similar. The compositions of the “first Fe—Si alloy,” the “second Fe—Si alloy,” and the “third Fe—Si alloy” may be identical or similar. The compositions of the “first Fe—Si—Cr—Al alloy” and the “second Fe—Si—Cr—Al alloy” may be identical or similar. The compositions of the “first Fe—Si—Cr—Ni alloy” and the “second Fe—Si—Cr—Ni alloy” may be identical or similar. The alloy compositions and contents thereof are shown in Table 1, in which the unit is weight percent (wt %), but the present disclosure is not limited thereto.

TABLE 1

| | Amorphous | Nanocrystalline | Fe—Si—Cr | Fe—Si—Al | Fe—Si | Fe—Si—Cr—Al | Fe—Si—Cr—Ni | Pure | Fe—Si |
|---|---|---|---|---|---|---|---|---|---|
| | alloy | alloy | alloy | alloy | alloy | alloy | alloy | iron | alloy |
| Fe | Balance | | | | | | | | |
| C | ≤1.0 | ≤0.1 | ≤0.03 | ≤0.03 | ≤0.03 | ≤0.03 | ≤2.0 | ≤0.2 | ≤0.05 |
| O | ≤0.5 | ≤0.3 | ≤2.0 | ≤2.0 | ≤2.0 | ≤2.0 | ≤0.5 | ≤2.0 | ≤0.5 |
| Si | ≤8.0 | ≤8.0 | ≤6.5 | ≤9.5 | ≤7.0 | ≤9.5 | ≤0.65 | — | — |
| Cr | ≤3.5 | ≤0.12 | ≤6.0 | — | — | ≤6.0 | ≤3.5 | — | — |
| Mn | — | — | ≤0.20 | — | — | — | — | — | — |
| Ni | — | — | ≤0.20 | — | — | ≤8.0 | ≤8.0 | — | 20~80 |
| Al | — | — | — | ≤6.0 | — | ≤6.0 | ≤0.1 | — | — |
| P | — | — | ≤0.04 | — | — | — | ≤7.5 | — | — |
| S | — | — | ≤0.03 | — | — | — | — | — | — |
| B | ≤3.5 | ≤2.5 | — | — | — | ≤2.0 | ≤0.55 | — | — |
| Nb | — | ≤6.0 | — | — | — | ≤6.0 | — | — | — |
| Pb | — | — | — | — | — | — | ≤0.011 | — | — |
| Co | — | — | — | — | — | — | ≤0.18 | — | — |
| Cu | — | ≤1.50 | — | — | — | ≤1.20 | — | — | — |

In some embodiments, the first magnetic powder in the alloy powder composition accounts for 10, 15, 20, 25, 30, 35, 40, 45, 50, 55, 60, 65, 70, 75, 80, or 85 weight percent. If the content of the first magnetic powder was less than 5 weight percent, the obtained alloy powder composition would have low permeability and high core loss. If the content of the first magnetic powder was greater than 90 weight percent, the compact would have a relatively low compaction density and the obtained alloy powder composition would have low packing density and low permeability.

In some embodiments, the second magnetic powder in the alloy powder composition accounts for 10, 15, 20, 25, 30, 35, 40, 45, 50, 55, 60, 65, 70, 75, 80, or 85 weight percent. If the content of the second magnetic powder was less than 5 weight percent, the obtained alloy powder composition would have low permeability and high core loss. If the content of the second magnetic powder was greater than 90 weight percent, the compact would have a relatively low compaction density and the obtained alloy powder composition would have low packing density and low permeability.

In some embodiments, the third magnetic powder in the alloy powder composition accounts for 10, 15, 20, 25, 30, 35, 40, 45, 50, 55, 60, 65, 70, 75, 80, or 85 weight percent. If the content of the third magnetic powder was less than 5 weight percent, the obtained alloy powder composition would have low permeability and high core loss. If the content of the third magnetic powder was greater than 90 weight percent, the compact would have a relatively low compaction density and the obtained alloy powder composition would have low packing density and low permeability. In some embodiments, when the third magnetic powder accounts for at least 6 weight percent, it is beneficial for obtaining the disclosed alloy powder composition having high packing density, high permeability, and low core loss.

In some specific embodiments, based on 100 weight percent of the alloy powder composition, the alloy powder composition is composed of 5 to 90 weight percent of the first magnetic powder, 5 to 90 weight percent of the second magnetic powder, and 5 to 90 weight percent of the third magnetic powder.

In some specific embodiments, based on 100 weight percent of the alloy powder composition, the alloy powder composition is composed of 10 to 80 weight percent of the first magnetic powder, 10 to 80 weight percent of the second magnetic powder, and 10 to 80 weight percent of the third magnetic powder.

In some specific embodiments, based on 100 weight percent of the alloy powder composition, the alloy powder composition is composed of 10 to 60 weight percent of the first magnetic powder, 20 to 70 weight percent of the second magnetic powder, and 20 to 70 weight percent of the third magnetic powder.

In some specific embodiments, based on 100 weight percent of the alloy powder composition, the alloy powder composition is composed of 10 to 40 weight percent of the first magnetic powder, 20 to 40 weight percent of the second magnetic powder, and 20 to 70 weight percent of the third magnetic powder. When the contents of the magnetic powders in the alloy powder composition are in the above ranges, the obtained alloy powder composition has high packing density, high permeability, and low core loss.

In some embodiments, a median particle diameter D50 of the first magnetic powder is 2 μm to 36 μm, for example, 4 μm, 4.5 μm, 6 μm, 6.5 μm, 7 μm, 8 μm, 9 μm, 10 μm, 12 μm, 15 μm, 18 μm, 20 μm, 22 μm, 23 μm, 26 μm, 30 μm, 32 μm, or 34 μm. In some embodiments, a 10th percentile particle size D10 of the first magnetic powder is 2 μm to 10 μm, for example, 4 μm, 6 μm, or 8 μm. In some embodiments, a 90th percentile particle size D90 of the first magnetic powder is 8 μm to 65 μm, for example, 10 μm, 20 μm, 30 μm, 40 μm, 50 μm, or 60 μm.

In some embodiments, a median particle diameter D50 of the second magnetic powder is 2 μm to 35 μm, for example, 3.5 μm, 4 μm, 4.5 μm, 6 μm, 6.5 μm, 8 μm, 10 μm, 11 μm, 12 μm, 15 μm, 16 μm, 17 μm, 18 μm, 20 μm, 21 μm, 23 μm, 26 μm, 28 μm, 30 μm, 32 μm, or 34 μm. In some embodiments, a 10th percentile particle size D10 of the second magnetic powder is 2 μm to 10 μm, for example, 4 μm, 6 μm, or 8 μm. In some embodiments, a 90th percentile particle size D90 of the second magnetic powder is 8 μm to 65 μm, for example, 10 μm, 20 μm, 30 μm, 40 μm, 50 μm, or 60 μm. In some embodiments, the particle diameter of the first magnetic powder may be greater than, equal to, or smaller than the particle diameter of the second magnetic powder.

In some embodiments, a median particle diameter D50 of the third magnetic powder is 0.5 μm to 15 μm, for example, 0.9 μm, 1.5 μm, 2 μm, 3.5 μm, 4 μm, 5 μm, 6 μm, 6.5 μm, 7 μm, 8 μm, 10 μm, or 12 μm. In some embodiments, a 10th percentile particle size D10 of the third magnetic powder is 0.5 μm to 3.5 μm, for example, 1 μm, 2 μm, or 3 μm. In some embodiments, a 90th percentile particle size D90 of the third magnetic powder is 1 μm to 16 μm, for example, 2 μm, 4 μm, 6 μm, 8 μm, 10 μm, 12 μm, or 14 μm.

It is worth noting that the particle size of the third magnetic powder is smaller than the particle size of the first magnetic powder and the particle size of the second magnetic powder, therefore, the third magnetic powder can fill the gaps between the first magnetic powder and the second magnetic powder, thereby improving the packing density of the alloy powder composition, and further improving the permeability of the alloy powder composition and reducing the core loss of the alloy powder composition. As a result, when the median particle diameters D50 of the first magnetic powder, the second magnetic powder, and the third magnetic powder are in the above ranges, it is beneficial for obtaining the disclosed alloy powder composition having high packing density, high permeability, and low core loss.

In the embodiments of the present disclosure, the alloy powder composition is subjected to a press-forming step to form a T18 ring core, wherein the T18 ring core has an outer diameter of about 18 mm, an inner diameter of about 10 mm, and a maximum height of about 5 mm.

In some embodiments, a density of the alloy powder composition is 5 g/cm³ to 8 g/cm³, for example, 5.2, 5.4, 5.5, 5.6, 5.8, 6, 6.2, 6.3, 6.35, 6.4, 6.5, 6.6, 6.8, 7, 7.2, 7.4, 7.5, 7.6, or 7.8 g/cm³. When the density of the alloy powder composition is in the above range, it is beneficial for obtaining the disclosed alloy powder composition having high permeability and low core loss. The density in the present application is measured on the T18 ring core according to a geometrical method or ASTM (American Society for Testing and Materials) B962, wherein ASTM B962 employs the Archimedes' method. The density of the T18 ring core is calculated by dividing the core's mass by its volume.

In some embodiments, a relative permeability (μᵣ) of the alloy powder composition is 10 to 70, for example, 20, 22, 24, 26, 28, 30, 32, 33, 34, 35, 36, 37, 38, 39, 40, 42, 43, 44, 46, 48, 50, 52, 54, 56, 58, 60, 62, 64, 65, 66, or 68, under test conditions at a frequency of 1 MHz. The relative permeability in the present application is measured on the T18 ring core according to IEC (International Electrotechnical Commission) 62044-2, and the (effective permeability; Je) and the relative permeability are obtained through calculation.

In some embodiments, a core loss of the alloy powder composition is 200 kW/m³ to 1500 kW/m³, for example, 300, 400, 500, 600, 700, 750, 800, 850, 900, 950, 1000, 1100, 1200, 1300, or 1400 kW/m³, under test conditions at a frequency of 1 MHz and a magnetic flux density amplitude of 30 mT. The core loss in the present application is measured on the T18 ring core using a B-H instrument according to IEC 62044-3.

In some embodiments, a Vickers hardness (HV) of the first magnetic powder is 300 MPa to 700 MPa, for example, 400 MPa, 500 MPa, or 600 MPa. In some embodiments, a Vickers hardness of the second magnetic powder is 300 MPa to 700 MPa, for example, 400 MPa, 500 MPa, or 600 MPa. In some embodiments, a Vickers hardness of the third magnetic powder is 100 MPa to 450 MPa, for example, 200 MPa, 300 MPa, or 400 MPa. In some embodiments, the Vickers hardness of the third magnetic powder is less than or equal to the Vickers hardness of the first magnetic powder and the Vickers hardness of the second magnetic powder. When the Vickers hardness of the first, second, third magnetic powders are in the above ranges, it is beneficial for improving the packing density of the alloy powder composition, thereby improving the permeability and reducing the core loss of the alloy powder composition. The Vickers hardness in the present disclosure is measured for the first, second, and the third magnetic powders using a nanoindentation testing machine.

The manufacturing method of the alloy powder composition is as follows. First, the first magnetic powder, the second magnetic powder, and the third magnetic powder are mixed. Then, the three magnetic powders are uniformly mixed with additives and colloids to obtain a magnetic powder composition. Next, the magnetic powder composition is subjected to a wet sieving and granulation step. Thereafter, the alloy powder composition of the present disclosure is obtained through a drying step and a dry sieving and granulation step.

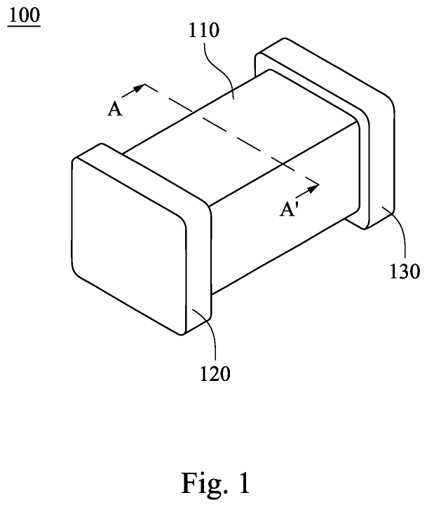

FIG. 1 is a schematic three-dimensional view of an inductor 100 in accordance with some embodiments of the present disclosure. Referring to FIG. 1, the inductor 100 includes a main body 110 and external electrodes 120 and 130. The external electrodes 120 and 130 are disposed at opposite ends of the main body 110, respectively.

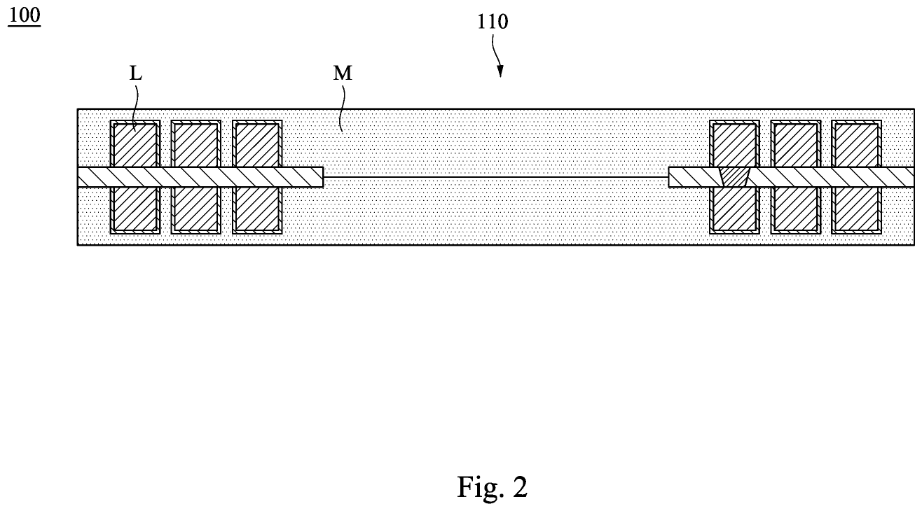

FIG. 2 is a cross-sectional view obtained from a line A-A′ in FIG. 1. Referring to FIG. 2, the inductor 100 includes a magnetic layer M and an electrically conductive circuit L disposed in the magnetic layer M, wherein magnetic layer M includes the above-mentioned alloy powder composition. The alloy powder composition may be, for example, magnetic core materials used in the inductor. It should be noted that the inductor 100 illustrated in FIG. 1 and FIG. 2 is merely one embodiment, and the disclosed alloy powder composition is not limited to its applications in the inductor 100.

The following Experimental Examples and Comparative Examples are provided to more specifically describe the technical features and advantages of the examples of the present disclosure, and are not intended to limit the present disclosure.

### Comparative Examples 1 and 2

Reference is made to Table 2 below. The binary alloy powder composition in Comparative Example 1 included 30 wt % of amorphous alloy and 70 wt % of pure iron. The alloy powder composition in Comparative Example 2 included 45 wt % of the amorphous alloy, 50 wt % of the nanocrystalline alloy, and 5 wt % of the Fe—Si—Cr alloy.

Because the alloy powder composition in Comparative Example 1 merely included two types of magnetic powders, in which its crystalline content was relatively low and its pure iron content was relatively high, the measured relative permeability was low, and the core loss was high.

TABLE 2

| | Alloy | | First | Second | Third |
|---|---|---|---|---|---|
| | powder | | magnetic | magnetic | magnetic |
| | composition | | powder | powder | powder |
| Comparative | Material | | Amorphous | No addition | Pure iron |
| Example 1 | | | alloy | | |
| | Content | (wt %) | 30 | NA | 70 |
| | D50 | (μm) | 23~36 | NA | 5~7 |
| | Density | (g/cm³) | 6.1~6.3 | | |
| | μᵣ @1 | MHZ | 24~28 | | |
| | Core loss | (kW/m³) | 1900~2300 | | |
| | @1 MHz/30 mT | | | | |
| Comparative | Material | | Amorphous | Nanocrystalline | Fe—Si—Cr |
| Example 2 | | | alloy | alloy | alloy |
| | Content | (wt %) | 45 | 50 | 5 |
| | D50 | (μm) | 23~36 | 11~23 | 2.5~6 |
| | Density | (g/cm³) | 5.7~6.2 | | |
| | Hr @1 | MHZ | 25~32 | | |
| | Core loss | (kW/m³) | 1100~1600 | | |

@1 MHz/30 mT

### Experimental Examples 1 to 6

Reference is made to Table 3 below. The same first, second, and third magnetic powders were used in Experimental Examples 1 to 3, in which their materials and median particle diameters D50 were the same. Because Experimental Examples 1 to 3 used different contents of the first, second, and third magnetic powders, the resulting densities, relative permeabilities, and core losses varied.

The relative permeabilities and core losses of the alloy powder compositions in Experimental Examples 1 to 6 were superior to those in Comparative Examples 1 and 2. Therefore, the disclosed alloy powder compositions were beneficial in improving the efficiency and high-frequency performance of inductors and improving power conversion efficiency.

TABLE 3

| | Alloy | | First | Second | Third |
|---|---|---|---|---|---|
| | powder | | magnetic | magnetic | magnetic |
| Experimental | composition | | powder | powder | powder |
| Example 1 | Material | | Amorphous | Nanocrystalline | Fe—Ni alloy |
| | | | alloy | alloy | |
| | Content | (wt %) | >0~20 | 10~30 | 60~80 |
| | D50 | (μm) | 23~36 | 11~23 | 0.9~1.5 |
| | Density | (g/cm³) | 6.3~6.8 | | |
| | μᵣ @1 | MHZ | 34~42 | | |
| | Core loss | (kW/m³) | 850~950 | | |
| | @1 MHz/30 mT | | | | |
| Example 2 | Material | | Amorphous | Nanocrystalline | Fe—Ni alloy |
| | | | alloy | alloy | |
| | Content | (wt %) | 20~40 | 20~40 | 30~50 |
| | D50 | (μm) | 23~36 | 11~23 | 0.9~1.5 |
| | Density | (g/cm³) | 6.2~6.6 | | |
| | μᵣ @1 | MHZ | | 37~44 | |
| | Core loss | (kW/m³) | 850~950 | | |
| | @1 MHz/30 mT | | | | |
| Example 3 | Material | | Amorphous | Nanocrystalline | Fe—Ni alloy |
| | | | alloy | alloy | |
| | Content | (wt %) | 10~30 | 20~40 | 40~60 |
| | D50 | (μm) | 23~36 | 11~23 | 0.9~1.5 |
| | Density | (g/cm³) | 6.4~6.8 | | |
| | μᵣ @1 | MHZ | 39~43 | | |
| | Core loss | (kW/m³) | 750~900 | | |
| | @1 MHz/30 mT | | | | |
| Example 4 | Material | | Amorphous | Nanocrystalline | Fe—Ni alloy |
| | | | alloy | alloy | |
| | Content | (wt %) | 10~30 | 10~30 | 50~70 |
| | D50 | (μm) | 15~22 | 10~17 | 0.9~1.5 |
| | Density | (g/cm³) | 6.2~6.5 | | |
| | μᵣ @1 | MHZ | 38~43 | | |
| | Core loss | (kW/m³) | 500~600 | | |
| | @1 MHz/30 mT | | | | |
| Example 5 | Material | | Nanocrystalline | Fe—Si—Cr alloy | iron |
| | | | alloy | | |
| | Content | (wt %) | 30~50 | 15~35 | 25~45 |
| | D50 | (μm) | 12~20 | 8~12 | 2~6 |
| | Density | (g/cm³) | 6.2~6.35 | | |
| | μᵣ @1 | MHZ | 28~33 | | |
| | Core loss | (kW/m³) | 1000~1300 | | |
| | @1 MHz/30 mT | | | | |
| Example 6 | Material | | Fe-Si alloy | Amorphous | Iron |
| | | | | alloy | |
| | Content | (wt %) | 15~35 | 25~45 | 30~50 |
| | D50 | (μm) | 7~12 | 15~20 | 4~8 |
| | Density | (g/cm³) | 6.2~6.4 | | |
| | μᵣ @1 | MHZ | 30~35 | | |
| | Core loss | (kW/m³) | 900~1200 | | |

@1 MHz/30 mT

### Experimental Examples 7 to 11

Reference is made to Table 4 below. The relative permeabilities and core losses of the alloy powder compositions in Experimental Examples 7 to 11 were superior to those in Comparative Examples 1 and 2. Therefore, the disclosed alloy powder compositions were beneficial in improving the efficiency and high-frequency performance of inductors and improving power conversion efficiency.

TABLE 4

| | Alloy | | First | Second | Third |
|---|---|---|---|---|---|
| | powder | | magnetic | magnetic | magnetic |
| Experimental | composition | | powder | powder | powder |
| Example 7 | Material | | Fe—Si—Cr—Ni | Fe—Si alloy | Fe—Ni alloy |
| | | | alloy | | |
| | Content | (wt %) | 30~50 | 30~50 | 10~30 |
| | D50 | (μm) | 10~12 | 3.5~6.5 | 0.9~1.5 |
| | Density | (g/cm³) | 6.1~6.5 | | |
| | μᵣ @1 | MHZ | 35~40 | | |
| | Core loss | (kW/m³) | 700~800 | | |
| | @1 MHz/30 mT | | | | |
| Example 8 | Material | | Fe—Si—Cr—Ni | Fe—Si—Cr—Al | Fe—Si alloy |
| | | | alloy | alloy | |
| | Content | (wt %) | 10~30 | 20~40 | 40~60 |
| | D50 | (μm) | 10~12 | 4.5~6.5 | 3.5~6.5 |
| | Density | (g/cm³) | 5.6~6.2 | | |
| | μᵣ @1 | MHZ | 27~34 | | |
| | Core loss | (kW/m³) | 800~900 | | |
| | @1 MHz/30 mT | | | | |
| Example 9 | Material | | Fe—Si—Cr—Ni | Fe—Si—Cr—Al | Fe—Si alloy |
| | | | alloy | alloy | |
| | Content | (wt %) | 10~30 | 20~40 | 40~60 |
| | D50 | (μm) | 10~12 | 4.5~6.5 | 0.9~1.5 |
| | Density | (g/cm³) | 6.4~6.8 | | |
| | μᵣ @1 | MHZ | | 34~39 | |
| | Core loss | (kW/m³) | 400~500 | | |
| | @1 MHz/30 mT | | | | |
| Example 10 | Material | | Fe—Si—Al alloy | Fe—Si alloy | Fe—Si—Al alloy |
| | Content | (wt %) | >0~20 | 60~80 | 10~30 |
| | D50 | (μm) | 9~12 | 8~12 | 2~6 |
| | Density | (g/cm³) | 6.3~6.6 | | |
| | μᵣ @1 | MHZ | 35~40 | | |
| | Core loss | (kW/m³) | 800~1000 | | |
| | @1 MHz/30 mT | | | | |
| Example 11 | Material | | Fe—Si—Cr—Al | Fe—Si—Al alloy | Fe—Si—Cr alloy |
| | | | alloy | | |
| | Content | (wt %) | 20~40 | 20~40 | 30~50 |
| | D50 | (μm) | 4.5~6.5 | 10~16 | 2~7 |
| | Density | (g/cm³) | 6.2~6.5 | | |
| | μᵣ @1 | MHZ | 32~37 | | |
| | Core loss | (kW/m³) | 900~1100 | | |

@1 MHz/30 mT

In summary, the alloy powder composition of the present disclosure includes three types of magnetic powders, wherein each magnetic powder includes the amorphous alloy, the nanocrystalline alloy, the crystalline alloy and/or a pure iron powder. The disclosed alloy powder composition has high packing density, high permeability, and low core loss, which is beneficial in improving the efficiency and high-frequency performance of inductors and improving power conversion efficiency.

The present disclosure has been disclosed as hereinabove, however it is not used to limit the present disclosure. Those skilled in the art may make various changes, substitutions, and alterations herein without departing from the spirit and scope of the present disclosure. Therefore, the scope of protection of the present disclosure shall be subject to the scope of the claims attached in the application.

What is claimed is:

1. An alloy powder composition, based on 100 weight percent of the alloy powder composition, comprising:
five to ninety weight percent of a first magnetic powder, wherein the first magnetic powder comprises a first amorphous alloy, a first nanocrystalline alloy, or a first crystalline alloy;
five to ninety weight percent of a second magnetic powder, wherein the second magnetic powder comprises a second amorphous alloy, a second nanocrystalline alloy, or a second crystalline alloy; and
five to ninety weight percent of a third magnetic powder, wherein the third magnetic powder comprises a pure iron powder or a third crystalline alloy.

2. The alloy powder composition of claim 1, wherein:
the first crystalline alloy comprises a first Fe—Si—Cr alloy, a first Fe—Si—Al alloy, a first Fe—Si alloy, a first Fe—Si—Cr—Al alloy, or a first Fe—Si—Cr—Ni alloy, the second crystalline alloy comprises a second Fe—Si—Cr alloy, a second Fe—Si—Al alloy, a second Fe—Si alloy, a second Fe—Si—Cr—Al alloy, or a second Fe—Si—Cr—Ni alloy, and
the third crystalline alloy comprises a Fe—Ni alloy, a third Fe—Si—Cr alloy, a third Fe—Si—Al alloy, or a third Fe—Si alloy.

3. The alloy powder composition of claim 1, wherein:
the first magnetic powder accounts for 10 to 80 weight percent;
the second magnetic powder accounts for 10 to 80 weight percent; and
the third magnetic powder accounts for 10 to 80 weight percent.

4. The alloy powder composition of claim 1, wherein:
the first magnetic powder accounts for 10 to 60 weight percent;
the second magnetic powder accounts for 20 to 70 weight percent; and
the third magnetic powder accounts for 20 to 70 weight percent.

5. The alloy powder composition of claim 1, wherein:
the first magnetic powder accounts for 10 to 40 weight percent;
the second magnetic powder accounts for 20 to 40 weight percent; and
the third magnetic powder accounts for 20 to 70 weight percent.

6. The alloy powder composition of claim 1, wherein:
a median particle diameter D50 of the first magnetic powder is 2 μm to 36 μm;
a median particle diameter D50 of the second magnetic powder is 2 μm to 35 μm; and
a median particle diameter D50 of the third magnetic powder is 0.5 μm to 15 μm.

7. The alloy powder composition of claim 1, wherein a density of the alloy powder composition is 5 g/cm³ to 8 g/cm³.

8. The alloy powder composition of claim 1, wherein a density of the alloy powder composition is 5.5 g/cm³ to 7.5 g/cm³.

9. The alloy powder composition of claim 1, wherein a relative permeability of the alloy powder composition is 10 to 70 under test conditions at a frequency of 1 MHz.

10. The alloy powder composition of claim 1, wherein a relative permeability of the alloy powder composition is 30 to 65 under test conditions at a frequency of 1 MHz.

11. The alloy powder composition of claim 1, wherein a core loss of the alloy powder composition is 200 kW/m³ to 1500 kW/m³ under test conditions at a frequency of 1 MHz and a magnetic flux density amplitude of 30 mT.

12. The alloy powder composition of claim 1, wherein a core loss of the alloy powder composition is 200 kW/m³ to 950 KW/m³ under test conditions at a frequency of 1 MHz and a magnetic flux density amplitude of 30 mT.

13. The alloy powder composition of claim 1, wherein:
a Vickers hardness of the first magnetic powder is 300 MPa to 700 MPa;
a Vickers hardness of the second magnetic powder is 300 MPa to 700 MPa; and
a Vickers hardness of the third magnetic powder is 100 MPa to 450 MPa.

14. The alloy powder composition of claim 13, wherein the Vickers hardness of the third magnetic powder is less than the Vickers hardness of the first magnetic powder and the Vickers hardness of the second magnetic powder.

15. The alloy powder composition of claim 13, wherein the Vickers hardness of the third magnetic powder is equal to the Vickers hardness of the first magnetic powder and the Vickers hardness of the second magnetic powder.

16. The alloy powder composition of claim 1, wherein a particle diameter of the first magnetic powder is greater than, equal to, or smaller than a particle diameter of the second magnetic powder.

17. The alloy powder composition of claim 1, wherein a particle size of the third magnetic powder is smaller than a particle size of the first magnetic powder and a particle size of the second magnetic powder.

18. An inductor, comprising:
a magnetic layer comprising the alloy powder composition of claim 1; and
an electrically conductive circuit disposed in the magnetic layer.
